(19) United States
(12) Patent Application Publication
(10) Pub. No.: US 2022/0114264 A1
(43) Pub. Date: Apr. 14, 2022

(54) Authentication Using Current Drawn by Security Device

(71) Applicant: Lexmark International, Inc., Lexington, KY (US)

(72) Inventors: James Howard Ellis, JR., Lexington, KY (US); Zachary Nathan Fister, Lexington, KY (US); Timothy John Rademacher, Richmond, KY (US); Jennifer Topmiller Williams, Lexington, KY (US)

(21) Appl. No.: 17/469,601

(22) Filed: Sep. 8, 2021

Related U.S. Application Data
(60) Provisional application No. 63/075,482, filed on Sep. 8, 2020.

(51) Int. Cl. G06F 21/60; G06F 21/64; G06F 21/79; G06F 21/73

(52) U.S. Cl. CPC G06F 21/602; G06F 21/64; G06F 2221/0751; G06F 21/73; G06F 21/79

(57) ABSTRACT

A method for determining authenticity of a component in an imaging device is disclosed. Embodiments of the present disclosure provide for a method for a device to use an electronic authentication scheme to authenticate a second device while overcoming vulnerabilities associated with sending data over a communication bus when performing authentication, by using information other than that transmitted over the shared bus as authentication parameters. Embodiments utilize the current drawn by a chip from a power source when the chip performs an operation in response to a command as an authentication parameter.

### CROSS REFERENCES TO RELATED APPLICATIONS

This application claims priority and benefit under 35 U.S.C. 119(e) from U.S. provisional application No. 63/075,482 titled “Authentication Using Current Drawn by Security Device,” having a filing date of Sep. 8, 2020.

### BACKGROUND

### 1. Field of the Disclosure

The present disclosure relates generally to authentication schemes, and more particularly to an authentication scheme that uses current drawn by a security device as the authentication parameter for authenticating the security device.

### 2. Description of the Related Art

In some imaging devices, electronic authentication schemes associated with consumable supply items are used to provide security. Consumable supply items may contain an integrated circuit chip or security device that communicates with a controller located in the imaging device. In such an arrangement, the controller may check the authenticity of the consumable supply item by sending a verification challenge thereto and determining if the consumable item correctly responds to the verification challenge. The authenticity is verified by the controller receiving from the supply item the correct response to the challenge. Otherwise, if the supply item does not respond correctly, the supply item may be detected as a clone or counterfeit and appropriate actions may be taken to protect against the use of unauthorized supply items to optimize performance of and/or prevent damage to the imaging device. However, the security of such authentication schemes may be vulnerable to reverse engineering attacks or “hacking.” For example, data transmitted over the communication bus may be at risk of being monitored and decrypted by an attacker allowing the attacker to reverse engineer the design of the supply item's security device. In addition, the digital logic netlist of the supply item's security device may be reverse engineered by the attacker using advanced silicon imaging equipment which may allow the attacker to produce clone or counterfeit devices capable of producing responses that are identical to that of an authentic device. As a result, many forms of hacking may expose details of the authentication schemes that allow unauthorized manufacturers to develop counterfeit supply items that could bypass and/or override authentication procedures, which may then allow the counterfeit supply items to still operate when installed in the imaging device. Accordingly, other means to improve security and protect against counterfeit supplies are desired.

### SUMMARY

Embodiments of the present disclosure provide for a method for a device to use an electronic authentication scheme to authenticate a second device. The second device includes an integrated circuit chip that communicates with a controller in the first device. The controller in the first device may check the authenticity of the chip in the second device by sending a verification challenge and determining if the second device correctly responds to the verification challenge.

To overcome vulnerabilities associated with sending data over a communication bus when performing authentication, the controller in the first device initiates an authentication procedure that uses information other than that transmitted over the shared bus as authentication parameters. For example, the controller on the first device can perform such an authentication procedure using information associated with current drawn by the second device from a power source when the chip on the second device performs an operation in response to communication(s) transmitted.

### BRIEF DESCRIPTION OF THE DRAWINGS

The accompanying drawings incorporated in and forming a part of the specification, illustrate several aspects of the present disclosure, and together with the description explain the principles of the present disclosure.

FIG. 1 illustrates an imaging system according to one example embodiment.

FIG. 2 is a block diagram of a shared bus system employing a bus master communicating with a plurality of supply items according to one example embodiment.

FIG. 3 is a chart illustrating a first example of current profiles associated with different supply items.

FIG. 4 is a chart illustrating a second example of current profiles associated with different supply items.

FIG. 5 is a flowchart illustrating a method of authenticating a supply item based on current drawn by the supply item according to one example embodiment.

FIG. 6 is a block diagram of an example embodiment that integrates an analog-to-digital converter (ADC) in the security device and uses the ADC in the security device for authentication by capturing an internal or external analog parameter.

FIG. 7 shows an example supply device current profile that illustrates the expected variation for different settings at an example lower frequency scale parameter.

FIG. 8 shows an example supply device current profile that illustrates the expected variation for different settings at an example middle frequency scale parameter.

FIG. 9 shows an example supply device current profile that illustrates the expected variation for different settings at an example higher frequency scale parameter.

### DETAILED DESCRIPTION

In the following description, reference is made to the accompanying drawings where like numerals represent like elements. The embodiments are described in sufficient detail to enable those skilled in the art to practice the present disclosure. It is to be understood that other embodiments may be utilized and that process, electrical, and mechanical changes, etc., may be made without departing from the scope of the present disclosure. Examples merely typify possible variations. Portions and features of some embodiments may be included in or substituted for those of others. The following description, therefore, is not to be taken in a limiting sense and the scope of the present disclosure is defined only by the appended claims and their equivalents.

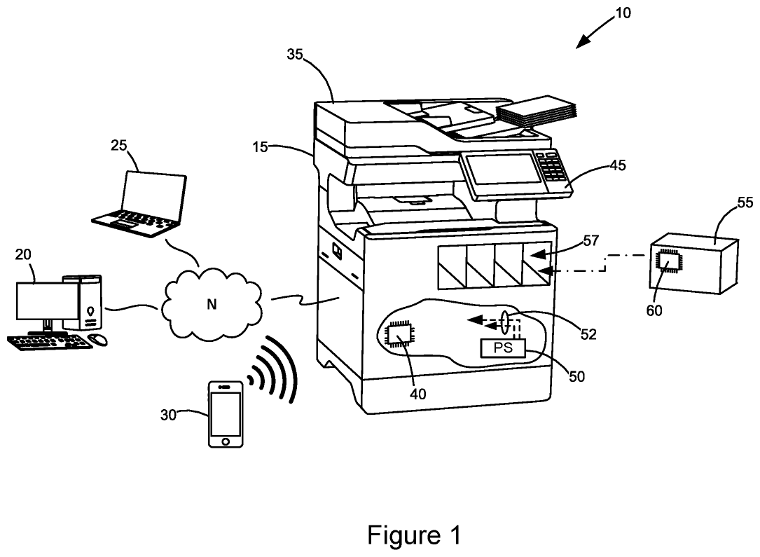

FIG. 1 shows a diagrammatic view of an imaging system 10 used in association with the present disclosure. Imaging system 10 includes an imaging device 15 used for printing images on sheets of media. Image data of the image to be printed on a media sheet may be supplied to imaging device 15 from a variety of sources such as a computer 20, laptop 25, mobile device 30, scanner 35, or like computing device. The sources directly or indirectly communicate with imaging device 15 via wired and/or wireless connections. Imaging device 15 includes a controller 40, a user interface 45, and a power supply unit 50. Controller 40 may include a processor and associated memory. In some example embodiments, controller 40 may be formed as one or more Application Specific Integrated Circuits (ASICs) or System-on-Chip (SoCs). Controller 40 may control the processing of print data. Controller 40 may also control the operation of a print engine during printing of an image onto a sheet of media. Power supply unit 50 typically includes analog circuitry necessary to convert AC voltage from the AC mains to one or more regulated DC voltages for use by components of imaging device 15. Power supply unit 50 may deliver appropriate regulated DC voltage levels to various components and circuitries via a power bus 52.

In one example embodiment, imaging device 15 employs an electronic authentication scheme to authenticate consumable supply items and/or replaceable units installed in imaging device 15. In FIG. 1, a representative supply item 55, such as a toner cartridge or an imaging unit, is shown. Supply item 55 may be installed in a corresponding storage area 57 in imaging device 15. Supply item 55 includes an integrated circuit chip or security device 60 that communicates with controller 40 in imaging device 15. Controller 40 may check the authenticity of supply item 55 by sending a verification challenge to security device 60 of supply item 55 and determining if security device 60 correctly responds to the verification challenge. The authenticity is verified by controller 40 receiving from the security device 60 the correct response to the challenge. Otherwise, if security device 60 in supply item 55 does not respond correctly, supply item 55 may be detected as a clone or counterfeit and appropriate actions may be taken to protect against the use of supply item 55 in order to optimize performance of and/or prevent damage to imaging device 15.

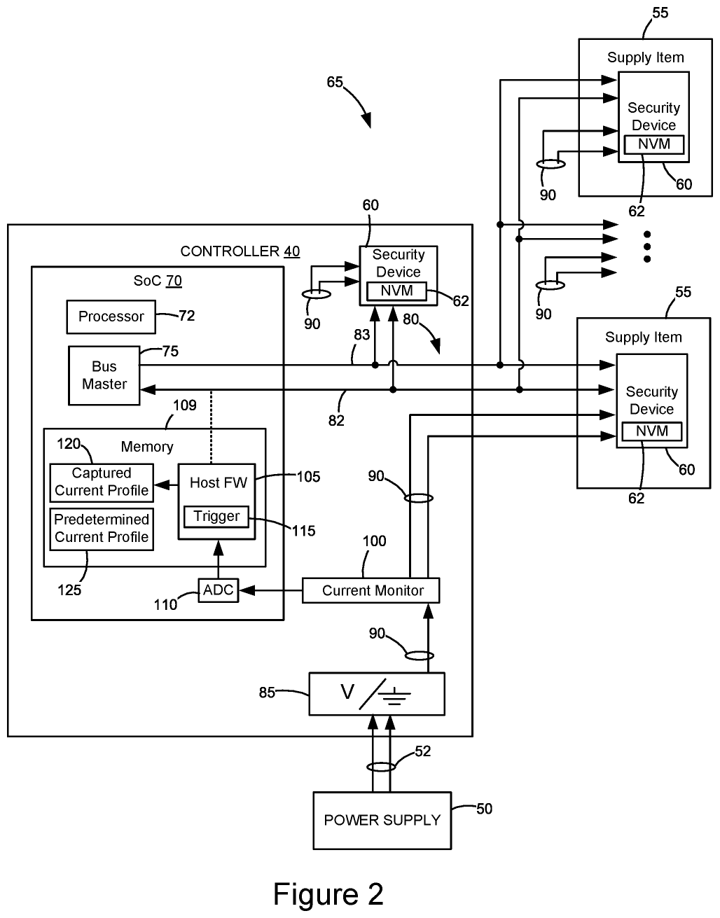

FIG. 2 illustrates a shared bus system 65 in which controller 40 communicates with a number of supply items 55. In the embodiment illustrated, controller 40 includes a System on Chip (SoC) 70 including a processor 72 and a bus master 75 that initiates and controls passing of communications including data, addresses, clock signals, and other control signals on a shared bus 80. Security device 60 in supply item 55 is configured as a slave device. Shared bus system 65 may employ the Inter-Integrated Circuit (“I2C”) protocol, although many other protocols can be utilized. One wire 82 of shared bus 80 carries data in a bidirectional manner, and the other wire 83 carries clock signals from bus master 75 to the security devices 60. Bus master 75 may employ an authentication scheme to verify authenticity of installed supply items 55. While shared bus 80 is illustrated as a two-wire serial bus, shared parallel bus structures or other wired structures may be utilized in other example embodiments. In yet other example embodiments, structures that facilitate communication between bus master 75 and supply items 55 may operate using wireless technology. Controller 40 includes a power source 85, shown as a voltage/ground source, that receives power from power supply unit 50 and delivers power to supply items 55 via a power bus 90, for example, when supply items 55 are installed in imaging device 15. As a result, supply items 55 operate by drawing power from power source 85.

In order to overcome the vulnerabilities associated with sending data over a communication bus, such as shared bus 80, when performing authentication, SoC 70 is configured to verify authenticity of installed supply items without using data transmitted over shared bus 80 as authentication parameters. Instead, SoC 70 utilizes signals transmitted over shared bus 80 as trigger signals to initiate an authentication procedure that uses information other than those transmitted over shared bus 80 as authentication parameters. In one example embodiment, SoC 70 performs such authentication procedure using information associated with current drawn by a supply item 55 from power source 85 when supply item 55 performs an operation in response to communication(s) transmitted over shared bus 80.

In the embodiment shown in FIG. 2, controller 40 includes a current monitor 100 that senses current passing through power bus 90 and outputs a voltage signal indicating current passing through power bus 90. Host firmware 105 running on SoC 70 uses the output of current monitor 100 to determine whether the supply item 55 drawing current from power source 85 is a valid or authentic component. Host firmware 105 may be stored in memory 109, which may be a flash memory and reprogrammable as needed. Sample data from the output of current monitor 100 are obtained by host firmware 105 as digitized data points from an analog-to-digital converter (ADC) 110 whose input is operatively connected to the output of current monitor 100. ADC 110 may be a portion of controller 40 or SoC 70, or separate therefrom. Current monitor 100 may be integrated into SoC 70 or separate therefrom.

Host firmware 105 is programmed to observe data signals transmitted over shared bus 80 such as, for example, data, addresses, control and/or command signals transmitted over wire 82 of shared bus 80. In this example, host firmware 105 is programmable to set at least one trigger condition 115 to enable sampling from the output of current monitor 100. In an example form, trigger condition 115 may be any control information from bus master 75 such as a command, a sequence of commands, or a combination of multiple commands sent by bus master 75 to security device 60 of supply item 55 over shared bus 80. In other examples, trigger condition 115 may be a single logical operation (e.g., a simple event performed by bus master 75) or a series of logic operations (e.g., a complex series of events performed by bus master 75). Trigger signals for SoC 70 to initiate capturing of samples from the output of current monitor 100 are thus generated based upon monitored commands as bus master 75 communicates with supply item 55 over shared bus 80.

Host firmware 105 is programmed to detect if a data signal observed from shared bus 80 satisfies the trigger condition 115. If a trigger condition is satisfied, host firmware 105 is configured to sample the output of current monitor 100 and generate a current profile 120 based on the output of current monitor 100, and then store the generated current profile 120 (also referred to herein as captured current profile 120) in memory 109. In general, captured current profile 120 is used by host firmware 105 to determine whether current drawn by a supply item 55 from power source 85 corresponds to a current draw response expected from an authentic supply item. Characterization data associated with an expected current draw response of supply item 55 when supply item 55 performs an operation in response to a command is stored in memory 109 as an expected or predetermined current profile 125. One or more predetermined current profiles 125 associated with different commands may be stored in memory 109. Each predetermined current profile 125 may be obtained empirically by performing tests and measurements on the response of several supply items to a particular command from bus master 75.

Host firmware 105 determines if supply item 55 is valid or authentic by comparing the captured current profile 120 with a corresponding predetermined current profile 125 pertinent to the command that initiated the generation of the captured current profile 120. If the captured current profile 120 and the corresponding predetermined current profile 125 substantially match, host firmware 105 may recognize the supply item 55 as valid or authentic. Otherwise, if the captured current profile 120 and the corresponding predetermined current profile 125 do not match, host firmware 105 may identify the supply item 55 as a clone, counterfeit or otherwise unauthorized component, and appropriate actions may be taken. For example, an error feedback may be provided and the user may be advised to acquire an authentic component via display or user interface 45. Other printing actions may also be enforced. Imaging device 15 may be configured to address such a situation to protect against the use of unauthorized supply items in order to optimize performance of and/or prevent damage to imaging device 15.

As discussed above, trigger condition 115 may correspond to control information sent to supply item 55. In one example embodiment, host firmware 105 may identify a particular command used in typical digital communication as a trigger condition. When host firmware 105 recognizes such command being sent over shared bus 80, host firmware 105 initiates a sampling process to capture samples of the output of current monitor 100 for a predetermined time period. The sample data points which represent the current draw of supply item 55 in response to the command are then stored in memory 109 as captured current profile 120 for further analysis.

In another example embodiment, trigger condition 115 may be selected based on the implementation complexity, accuracy, unique modes, and/or other features or factors associated with security device 60 of supply item 55. For example, trigger condition 115 may correspond to a command that is known to result in a maximum power consumption of security device 60 because such command utilizes more of the system resources of security device 60 than a typical operation. Conversely, trigger condition 115 may correspond to a command that is known to result in a minimum power consumption of security device 60 because such command utilizes less of the system resources of security device 60 than a typical operation. In these examples, a determination can be made whether a supply item is authentic by comparing the captured current profile 120 with predetermined threshold levels. For example, if a maximum power consumption of supply item 55 is expected when performing an operation in response to a command, supply item 55 may be recognized as authentic if at least one sample data point of the captured current profile 120 is equal to or above a first threshold level indicating maximum power consumption. Otherwise, supply item 55 may be determined as counterfeit. On the other hand, if a minimum power consumption of supply item 55 is expected when performing an operation in response to a command, supply item 55 may be recognized as authentic if sample data points of the captured current profile 120 are below a second threshold level indicating minimum power consumption. Otherwise, supply item 55 may be determined as counterfeit. Other examples may utilize averaging of the sampled data points of the captured current profile 120 and comparing the average value with predetermined threshold levels.

In another example embodiment, a command that is set as trigger condition 115 may be used to initiate a secondary internal operation in security device 60 that results in a distinct current profile. In this example, the secondary internal operation is different from the primary internal operation performed by security device 60 in response to the command. The secondary internal operation may be performed by security device 60 before or after the primary internal operation. Accordingly, when host firmware 105 determines that such command has been sent over shared bus 80 satisfying trigger condition 115, host firmware 105 enables sampling from the output of current monitor 100 allowing host firmware 105 to capture the distinct current profile. In one example, security device 60 may initiate the secondary internal operation after receiving the same command a predetermined number of times. In other examples, security device 60 may initiate the secondary internal operation after receiving a sequence of different commands.

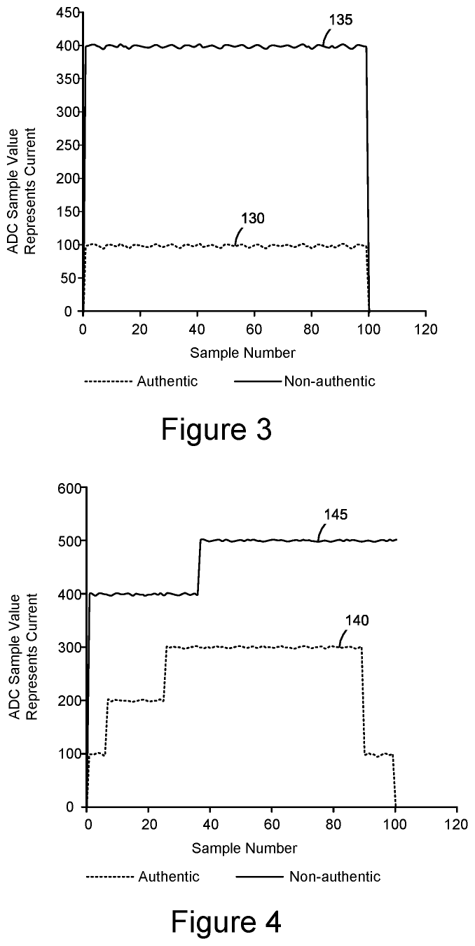

During sampling, the output of current monitor 100 is sampled to collect current draw data points via ADC 110 for a predetermined time period. Current draw data is typically normalized and a vector representing the captured current profile 120 is stored in memory 109. In one example embodiment, sampling may be implemented by capturing a number of sequential samples at a fixed threshold (for example, at quiescent device state) resulting in a substantially uniform current profile. In the example shown in FIG. 3, an authentic supply item exhibits a substantially uniform current profile 130 (matching that of a corresponding predetermined current profile 125 stored in memory 109). A supply item may be identified as invalid or counterfeit if it exhibits a current profile that deviates from the expected current profile by a predetermined amount, such as shown by current profile 135 of a non-authentic supply item. The captured current profile may be checked for various characteristics (e.g., voltage levels, periodicity, or other unique features) that don't require a comparison to a saved profile, but rather specific validation of the features of interest.

In another example embodiment, sampling may be implemented by capturing sample data points at different time periods of operation of security device 60 resulting in a unique current profile pattern such as shown, for example, by current profile 140 in FIG. 4. A more detailed profile that reflects unique periods of security device operation may be more robust against emulation by a clone device. In the example shown FIG. 4, a non-authentic supply item exhibits a current profile pattern 145 that fails to emulate the current profile pattern 140 of an authentic supply item. As will be appreciated, the current profiles shown in FIGS. 3 and 4 are only for illustration purposes and do not necessarily represent actual measured profiles, and thus should not be considered limiting.

In another example embodiment, profile analysis may be performed based on the time period of operations of security device 60 of supply item 55. In this example, to determine authenticity of a supply item, the amount of time it takes for a particular current profile (or portions thereof) to be generated during operation of a security device in response to a command may be compared with an expected time period to execute the command and generate the expected current profile. If the captured current profile is generated within the expected time period, supply item 55 may be identified as authentic. Otherwise, the supply item may be identified as a clone or non-authentic.

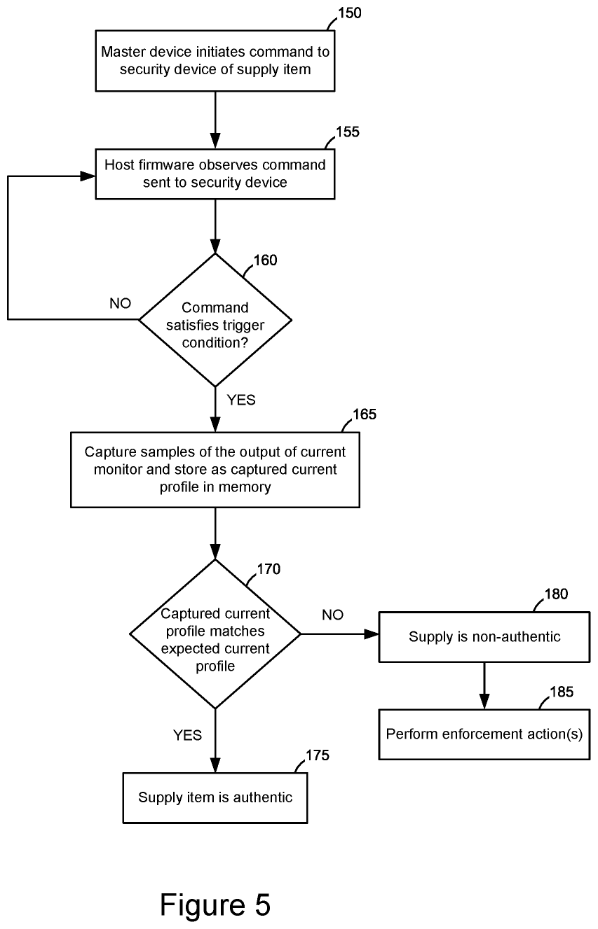

Referring now to FIG. 5, an example method for determining authenticity of a supply item 55 based on current drawn by supply item 55 will be described. At block 150, bus master 75 initiates a command to security device 60 of supply item 55. Host firmware 105 observes the command sent to security device 60 at block 155. At block 160, a determination is made whether the command sent to security device 60 satisfies trigger condition 115. When it is determined at block 160 that the command does not satisfy trigger condition 115, host firmware 105 continues to observe commands sent to security device 60 at block 155. When it is determined at block 160 that the command satisfies trigger condition 115, samples of the output of current monitor 100 are captured and stored in memory 109 as captured current profile 120 at block 165. At block 170, a determination is made whether the captured current profile 120 matches a corresponding expected/predetermined current profile 125. When it is determined at block 170 that the captured current profile 120 matches the corresponding expected/predetermined current profile 125, an indication may be made that supply item 55 is operating normally, as expected, and is a valid supply item at block 175. When it is determined at block 170 that the captured current profile 120 does not match the corresponding expected/predetermined current profile 125, and indication may be made that supply item 55 is not operating normally and is a clone or non-authentic supply item at block 180. At block 185, one or more enforcement actions may be performed to protect against the use of the non-authentic supply item.

The authentication scheme discussed above may be initiated based on or in response to predetermined events occurring in imaging device 15. For example, host firmware 105 may initiate the authentication procedure when certain commands are transmitted over shared bus 80 when imaging device 15 is initially turned on, after imaging device 15 has been reset, after exiting sleep mode, when an access door or a media tray is closed, or once every predetermined number of page(s) of printing.

As is apparent from the foregoing description, the authentication scheme of the present disclosure using current drawn by supply items as authentication parameters can be used to further complicate efforts by attackers and clone manufacturers to bypass underlying authentication processes that rely on information sent over the communication bus. More particularly, if attackers are able to program a clone device to correctly respond to requests or commands issued by the master device, the clone device may not have a circuit design that results in an identical current profile as that of an authentic device when the clone device responds to such requests or commands due to several factors associated with design implementation that affect power profile such as the number of logic gates, technology node, vendor logic cell characteristics, architecture, non-volatile memory (NVM) technology, and many other design aspects. In addition, trigger conditions, profile analysis, and enforcement are reconfigurable and/or programmable by the host firmware to accommodate different product configurations as well as to be adaptable to identify different clone devices.

A current monitoring system has been described that may be used to authenticate security devices. Presented below are specific commands and methodologies executed on the security devices that may be used in conjunction with the current monitoring system described in that application.

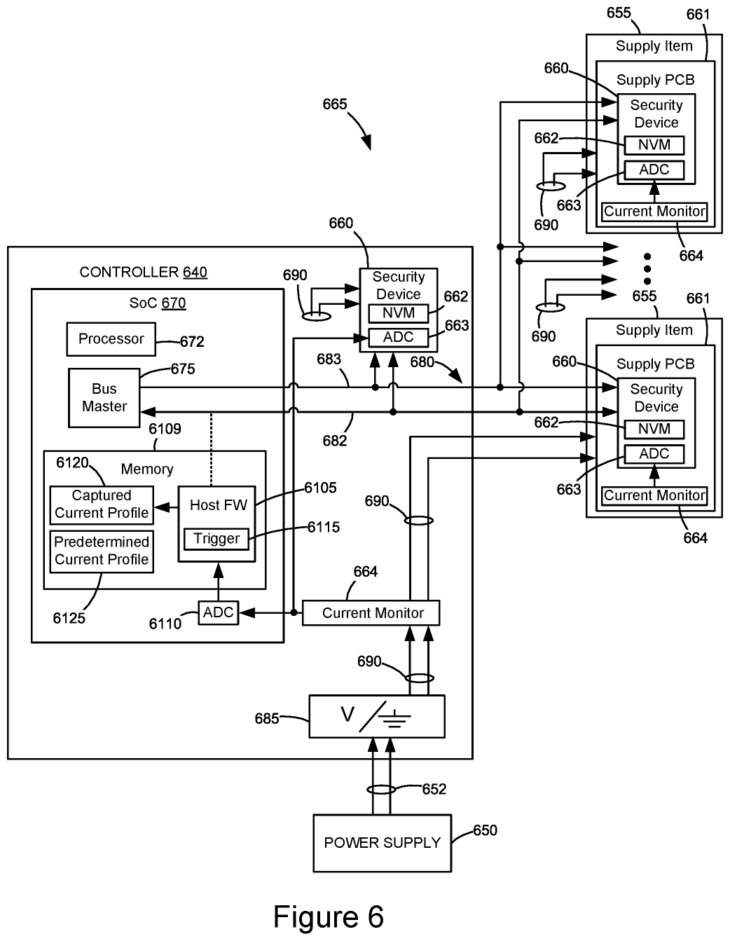

FIG. 6, described in detail below, is a block diagram of an example embodiment that integrates an analog-to-digital converter (ADC) in the security device and uses the ADC in the security device for authentication by capturing an internal or external analog parameter.

### Frequency Scaled Command Responses

A command is sent from the host that executes crypto operations on the supply device with the data result verified by the system device. In addition to this typical data verification, the current drawn by the device during the command execution is simultaneously being measured by the current monitoring system. The specific command in this implementation does multiple iterations of the RSA operation, such that a current profile of sufficient time period may be observed. The RSA operation is chosen in this implementation because it generates a measurable current profile, although a different crypto operation could also be chosen.

A frequency scale parameter (freqScale) is sent as part of the command data. The valid freqScale range is 0 to 31 which determines the supply device clock frequency as follows:

$$\sqrt{clock frequency = \frac{( freqScale + 1 )}{32} \times max clock frequency}$$

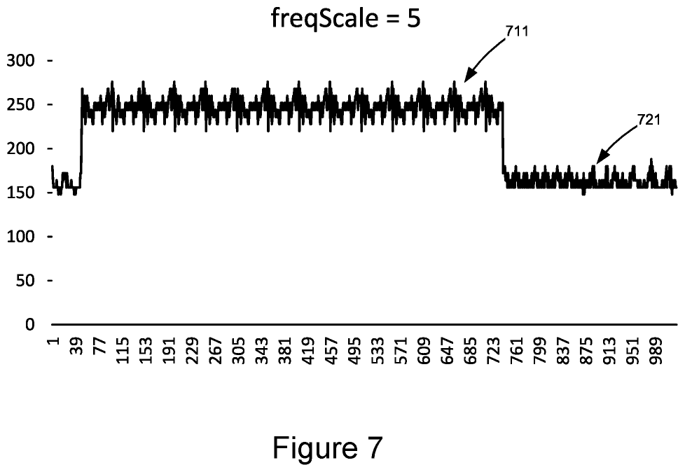

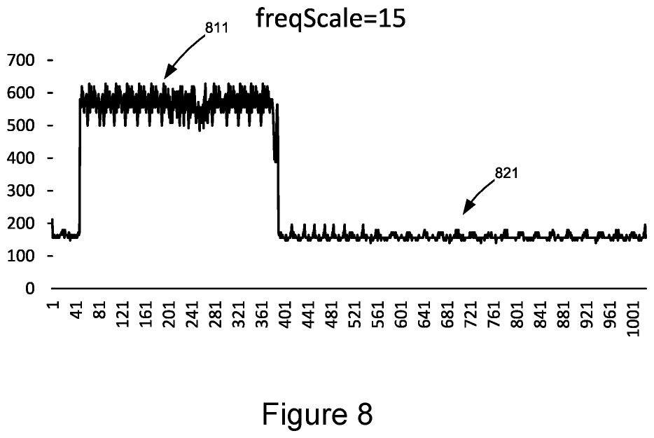

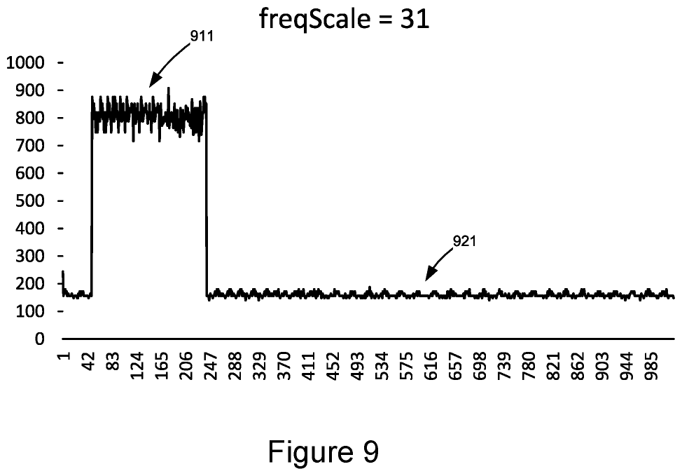

For lowerfreqScale values, the supply device clock frequency is also lower, so the command execution time period is expected to increase on an authentic device. Directly proportional to the clock frequency is the current drawn by a device, so the average current drawn during the command decreases as clock frequency decreases. The average value of samples as well as the number of samples above baseline value are used to validate an authentic device by observing its current profile for multiple freqScale settings. FIG. 7 shows an example supply device current profile to illustrate the expected variation for different settings, here, freqScale=5; FIG. 8 shows the same forfreqScale=15; FIG. 9 shows the same for freqScale=31.

This command uses the supply device's frequency scaling capability to generate a response difference that is only measurable via the current monitoring system on the host. It has an advantage over typical authentication commands because the difference is not measurable via the data communication bus. A further advantage is that the detection algorithm measures relative differences between settings such that the amplitude or duration may vary without affecting accuracy. Reasons for variation may include the number of devices on the same power bus or device to device process variation.

### Device Responses Based on Unique Personalization Value

It is advantageous to have a current profile that varies between supply devices to increase the difficulty for a non-authentic device to accurately mimic an authentic device profile. Varying the response of the command by using a unique personalization value without changing the data sent over the command interface adds another level of difficulty for an attacker to overcome. Additionally, running the same command on both the system device and supply devices is beneficial because the profile is expected to be similar, which makes the detection more robust. The system device profile is used as a reference as it's generally considered less likely to be cloned. The following command has these attributes.

A crypto operation (e.g. ECDH) is run by both the system device and supply device with the supply device's response verified by the system device. The choice of crypto operation may be one that has hardware crypto support on the device or uses device resources in a way such that the current profile is distinguishable by the current monitoring system.

In the current implementation, the security level of the command is the setting that will be varied which correspondingly alters the time period of the current profile for the command. The number/spacing of security level settings should be chosen to show a measurable difference in the current profiles between settings. In another implementation a different attribute such as the crypto function may be the setting that varies.

The chosen setting depends on a value that is unique for each device. For instance, the device id is a unique personalization value that is previously read from device memory so it's known by the host. The data value must also be known by the system device in order to determine the setting. To protect the data that determines the setting, a value may be chosen that is already known by both the system device and the host. Alternatively, the necessary data can be sent in an encrypted format to the system device and an algorithm known by both the host and system device can securely determine the setting. One option for this format is a keyed hash:

\sqrt{Setting=Hash(Key∥Device ID)mod(number of settings)}

In the preferred embodiment, Hash is the 256-bit secure hash algorithm 2 (SHA-2), the key is a 128-bit value that is stored inside each of the devices, and the device id is unique 32-bit value.

To execute this command and verify authenticity, the host picks a supply, but first runs the command on the system device. The system device determines the setting to use and operates the command at the same setting as will be used subsequently for the supply device. The host then runs the command on the supply and compares the two current measurements. If the supply device current measurement is determined to be statistically similar enough to that of the system, then the supply device is considered authentic. This implementation is an example use of the “Dynamic Expected Current Profiles” authentication method described in more detail below.

### Indirect Device Operations

An internal chip operation runs at a certain time or varies depending on a personalization parameter (e.g., internal operation runs after x recon commands depending on NVM value y). This operation would have a current profile that can be measured by the current monitoring system but is not tied to a specific command on the bus to make it more difficult to detect and less likely for a non-authentic device to reproduce. This operation would need to run at a time that would not impact normal operation performance, but also at a time that can be predicted by the host to enable the sampling period.

### Multiple Device Operations in Parallel

Typically, there are multiple supply devices installed on a printer platform (for multiple cartridges, imaging unit(s), and fuser). However, a single host controller or system device is usually required to authenticate each supply device so only one device is interacted with at a time. Running operations on multiple supply devices in parallel could be an unexpected challenge for a clone device to overcome and could provide unique current profiles compared to those run on a single device.

One example implementation is to utilize the Frequency Scaled command described above. Multiple devices could respond to this command at the same time, resulting in a unique current profile due to the cumulative current consumed. The number of iterations or frequency scale value could be varied on a device-to-device basis, creating several different combinations of profiles, depending on which devices are active.

A general call address must be implemented for the devices to respond in parallel simultaneously. A dedicated address could be reserved for this purpose within the address change algorithm. Alternatively, the device operations could be long enough in duration or delayed such that the devices could still be addressed individually and have overlap in their current profile.

The measurement of the cumulative current profile is the primary goal of this test, so the devices may not be required to respond to the host or a limited amount of response data or acknowledgement could be queried by the host for each device in series. All devices could respond similarly on the communication bus but may have different current profiles (or none at all) making it difficult for a clone device to replicate.

### Device Generated Command

A method of authenticating a security device on a supply item (shown in FIG. 5) has been described that uses information associated with current drawn by the security device as an authentication parameter. This information, referred to as a current profile 165, (examples shown in FIG. 3 and FIG. 4), is captured in response to a command from a master device 150 when host firmware 155 determines the command satisfies a trigger condition 160. Several examples of commands from a master device 150 have been described including standard cryptographic operations (such as encryption or decryption) with many variations (such as frequency or security level or payload) to provide many challenge/response pairs, where the challenge (the command) and the response (the current profile), are used to authenticate security devices 60 using the current profile methods disclosed herein.

As previously discussed, it is desirable to reduce the communication that is sent to and from the security device over the shared bus because of the risk that it could be reverse engineered and copied. A significant benefit of authenticating security devices using current profiles is that the security device does not provide a response (the current profile) to the challenge (the command) over the shared bus. Similarly, it would also be beneficial to prevent reverse engineering of communication over the shared bus if the master device does not send the challenge (the command) over the shared bus. The following discloses a method of authenticating security devices where both the challenge (the command) and the response (the current profile) are not sent over the shared bus eliminating the threat of reverse engineering of both the challenge and the response communicated over the shared bus.

A method to authenticate a security device, that eliminates the communication of the challenge and the response over the shared bus, consists of a command (the challenge) that is self-generated by the security device being authenticated, using a portion of a unique shared secret key, known only to the security device being authenticated and another security device performing the authentication in whole or in part, as an index into a table of commands and associated parameters, stored in the NVM of each security device, where each command and associated parameter may be used as an authentication challenge (the command), and using a current monitor circuit and an ADC to capture a current profile as a response to the challenge when the command and associated parameters are executed on the security device being authenticated, and comparing the captured current profile with the expected current profile, where the expected current profile is dynamically generated from another security device or predetermined and stored in memory as one or more expected current profiles that are determined by the same index derived from the shared secret key from another security device, and determining the security device to be authentic if a match is found and determining the security device to be non-authentic if no match is found.

Consider the system illustrated in FIG. 2 where a security device 60 is placed on the controller 40 and a security device 60 is placed on a supply item 55. All the security devices 60 are connect to the SoC device 70 that is placed on the controller 40. The SoC 70 acts as the bus master 75 of the shared bus 80 and each security device 60 act as a bus slave. The host SoC 70 and the security device 60 on the controller 40 may establish a unique secure communication session using a cryptographic protocol and a unique shared secret key (pre-shared or algorithmically generated) that is only known to those two devices. Likewise, the security device 60 on the controller 40 and each security device 60 on a supply item 55 may establish a unique secure communication session using a cryptographic protocol and a unique shared secret key (pre-shared or algorithmically generated) that is only known to those two security devices.

It can be observed that some portion of the shared secret key between the security device 60 on the controller 40 and the security device 60 on the supply item 55 may act as an index into a table of commands and associated parameters where each command and associated parameters may be used as an authentication challenge. These commands and parameters may be static and preprogrammed in the NVM 62 of each security device 60 at the factory, or they may be dynamic and occasionally be (re)programmed in the NVM 62 of each security device 60 by host firmware in the printer. Since the shared secret key between the security device 60 on the controller 40 and the security device 60 on the supply item 55 may be changed periodically, the command the security device 60 generates as an authentication challenge will change periodically as well. Since both the security device 60 on the controller 40 and the security device 60 on the supply item 55 independently know (without any external communication) which command to execute as the authentication challenge, the specific command that is executed by the security device 60 to generate a current profile (the response) is never sent over the over the shared bus 80.

The bus master device 75 in the SoC 70 on the controller 40 starts the authentication process by sending a single “authenticate by current profile” command to the security device 60 on the controller 40 and to the security device 60 on the supply item 55. The security device 60 on the controller 40 and the security device 60 on the supply item 55, then use a portion of the same unique shared secret key to lookup the same command and associated parameters from the table of commands and associated parameters stored in their NVM. The portion of the unique shared secret key to use depends on the number entries in the table of commands and associated parameters. For example, if there are 256 entries of commands and associated parameters in the table, then the unique shared secret key is truncated to the 8 least significant bits to form the index into the table. It is now possible for the security device 60 on the controller 40 and a security device 60 on a supply item 55 to self-generate the same command and associated parameters (the authentication challenge) by using the same independently determined table index to look up the command and associated parameters.

The security device 60 on the supply item 55 executes the command and the associated parameters (the challenge), that were read from the table based on the index derived from the shared secret key, and draws a current from the power bus 90 that is sensed by the current monitor 100 and input to the ADC 110 where it is converted into a one or more digital values which are stored in memory 109 as the captured current profile 120 when the trigger condition 115 is detected by host firmware 105.

The security device 60 on the controller 40 executes the same command and the associated parameters (the challenge), that were read from the table based on the index derived from the shared secret key, and draws a current from the power bus 90 that is sensed by the current monitor 100 and input to the ADC 110 where it is converted into a one or more digital values which are stored in memory 109 as the expected current profile when the trigger condition 115 is detected by host firmware 105. Alternatively, the security device 60 on the controller may simply return the index of the table of commands over the shared bus to the SoC 70 on the controller 40 where the SoC would determine which predetermined current profile 125 to read from memory based on the index received from the security device 60 on the controller 40.

The SoC 70 then compares 170 the captured current profile 120 with the expected current profile 125 and determines that the security device 60 on the supply item 55 is authentic 175 if the two current profiles match and determines that the security device 60 is non-authentic if the two current profiles do not match 180. This completes the one-way authentication of the security device 60 on the supply item 55. Additionally, the roles of the security devices 60 can be reversed and the security device 60 on the controller 40 may be authenticated in a similar manner. As a result of this method of self-generating commands used as authentication challenges, the communication of both the challenge and the response over the shared bus is eliminated and the threat of reverse engineering of the challenge and the response over the shared bus is eliminated.

### Device Authentication Methods

A method of authenticating a security device on a supply item (shown in FIG. 5) has been described that uses information associated with current drawn by the security device as an authentication parameter. This information, referred to as a current profile 165, (examples shown in FIG. 3 and FIG. 4), is captured in response to a command from a master device 150 when host firmware 155 determines the command satisfies a trigger condition 160. As shown in FIG. 2, the trigger condition 115 may be determined by the host firmware 105 operating on the SoC 70 on the controller 40. In addition, the trigger condition may be determined by device firmware (not shown) operating on the security device 60 on the supply item 55 or by device firmware (not shown) operating on the security device 60 on the controller 40. When the trigger condition is determined by device firmware (not shown) operating on a security device 60, the detection of a trigger condition may be communicated to the SoC 70 on the controller 40, by an encrypted message over the shared bus 80 or by a direct connection (e.g., an interrupt signal, not shown) to the SoC 70. When the SoC 70 receives notification of the trigger condition from the security device 60, it obtains the output of the current monitor 100 as digitized data points from the ADC 110 as previously described.

To determine authenticity of the security device 60 on the supply item 55, the captured current profile 120 of the security device 60 is compared with an expected current profile 125, that has been predetermined by laboratory characterization, and stored in memory 109 on the controller 40. If the captured current profile 165 matches the expected current profile 170, the supply item 55 is determined to be authentic 175 and if the current profiles do not match the supply item 55 is determined to be non-authentic 180. In addition, the same method of generating and capturing a current profile from the security device 60 on the controller 40 may be used to compare the captured current profile with the expected current profile to determine the authenticity of the security device 60 on the controller 40. If the captured current profile matches the expected current profile, the security device 60 on the controller is determined to be authentic and if the current profiles do not match the security device 60 on the controller is determined to be non-authentic.

Many types of comparison algorithms with predetermined thresholds may be used to determine if the captured current profile matches the expected current profile to determine the authenticity of security devices 60. These comparison algorithms with a predetermined threshold may be executed in whole or in part on the SoC 70 on the controller 40 or they may be executed in whole or in part on one or more security devices 60 a supply item 55 or they may be executed in whole or in part on the security device 60 on the controller 40. Any combination of execution of the comparison algorithm with predetermined threshold in whole or in part are possible including execution in whole or in part on the SoC 70 on the controller 40 or execution in whole or in part on a security device 60 on the supply item 55 or execution in whole or in part on a security device 60 on the controller 40.

When the comparison algorithm with predetermined threshold is executed in whole on only one device (SoC 70 or security device 60), the result of the whole comparison from the one device determines the security device 60 to be authentic 175 if whole comparison shows the captured current profile matches the expected current profile and if not the security device 60 is determined to be non-authentic 180.

When the comparison algorithm with predetermined threshold is executed in whole on multiple devices (SoC 70 or security devices 60), the result of the whole comparison from each device are combined by one device (SoC 70 or security device 60) that determines the security device 60 to be authentic if a majority of the whole comparisons show the captured current profile matches the expected current profile and if not the security device 60 is determined to be non-authentic 180.

When the comparison algorithm with predetermined threshold is executed in part on multiple devices (SoC 70 or security devices 60), the result of the partial comparison from each device are combined by one device (SoC 70 or security device 60) that determines the security device 60 to be authentic if the combination of the partial comparisons show the captured current profile matches the expected current profile and if not the security device 60 is determined to be non-authentic 180.

When the whole comparison is performed by the SoC 70, it may perform an enforcement action 185 if required and when the whole comparison is performed by a security device 60, the result of the whole comparison is sent to the SoC 70 on the controller 40 over the shared bus 80 and the SoC 70 may perform an enforcement action 185 if required.

### Device Specific Current Profiles

To minimize false positives (authentic device determined to be non-authentic) and false negatives (non-authentic device determined to be authentic), the comparison algorithm and predetermined threshold used to determine authenticity must allow for the variation in current drawn by an authentic security device due to the variation in voltage, temperature, and semiconductor processing. Since there are a finite number of predetermined current profiles 125 stored in memory 109 and there are a large number of authentic security devices (with a wide range of current profiles) to authenticate, a relaxed predetermined threshold may be required to avoid false positives. However, a relaxed predetermined threshold to avoid false positives may enable non-authentic security devices to be erroneously matched, resulting in a loss of authentication accuracy. As a result, it is desirable minimize the relaxation of the predetermined threshold.

The method to improve the authentication accuracy of a security devices placed on a supply item or on a controller using information associated with current drawn by a security device, in response to a trigger condition, and captured in memory as a current profile is to store expected current profiles that are device-specific in the non-volatile memory (NVM) in each security device. This is accomplished by obtaining one or more current profiles of each security device in response to one or more trigger conditions at the time of manufacture and storing them in the NVM 62 of the security device 60 as device-specific predetermined current profiles instead of characterizing several different security devices in the laboratory before manufacturing and storing one or more non-device-specific current profiles 125 in memory 109 on the controller 40. The benefit is that much of the variation in the current response of a security device is reduced and a more stringent predetermined threshold may be used to increase authentication accuracy.

In addition, it is desired to protect the device-specific, expected current profile(s) stored in NVM 62 in a security device 60 on a supply item 55 and on the controller 40 from tampering and from copying by an attacker. The method to protect the device-specific, expected current profile(s) stored in NVM in a security device from being copied is to encrypt them using an encryption algorithm (such as AES) and a secret key. The method to protect the device-specific, expected current profile(s) stored in the NVM 62 in a security device 60 from tampering is to combine the device-specific, expected current profile(s) with some additional device specific information (such as a serial number or part number) and generate a digital signature using a digital signature algorithm (such as ECDSA) and a private key. Both the expected current profile(s) and the digital signature are encrypted with a device specific secret key and stored in the NVM 62 of the security device 60 on the supply item 55 or on the controller 40.

In the printer during operation, the SoC 70 on the controller 40 may command the security device 60 on the controller 40 or on the supply item 55 to read the device-specific, expected current profile(s) and digital signature from NVM 62 in the security device 60 The security device 60 executes the command by reading the current profile(s) and digital signature from the NVM 62, decrypting them with the device specific secret key, and then encrypting them with a secret session key, and finally communicating the encrypted current profile(s) and digital signal over the shared bus 80 to the SoC 70 The SoC 70 decrypts the expected current profile and digital signature, using the secret session key, and verifies the digital signature is authentic using a digital signature verification algorithm and a public key. Once verified and decrypted in plaintext form, the device-specific, expected current profiles may be compared with the captured current profile using a verification algorithm and predetermined threshold to verify the authenticity of the security device 60 on the supply item 55 and on the controller 40 using any of the methods previously described. Furthermore, the security device 60 may also verify the digital signature by executing a digital signature verification algorithm using a public key before communicating the expected current profile and digital signature, either as encrypted ciphertext or decrypted plaintext, to the SoC 70 over the shared bus 80. Finally, the expected current profile stored in the NVM 62 of the security device 60 may be a device specific current profile as described or it may be a non-device specific expected current profile that is the same for all security devices 60.

### Dynamic Expected Current Profiles

In the embodiments previously described, and illustrated in FIG. 2, the expected current profiles of security devices 60 are predetermined and obtained by characterization in the laboratory or during manufacturing and stored statically at rest in memory 109 on the controller 40 or in non-volatile memory (NVM) 62 in the security device 60 on the controller 40 or in NVM 62 in the security device 60 on supply items 55.

An improvement to these embodiments would be to eliminate the storage of any predetermined current profiles statically in memory where they could be reverse engineered by an attacker and used to compromise security. In addition, it is desirable to have a very large number of trigger conditions (challenges) and associated expected current profiles (responses) to reduce the vulnerability to a replay attack. Both these improvements may be realized when a first instance of a security device 60 is used on the controller 40 (referred to as the system security device) and another instance of the same security device 60 is used on the supply item 55 (referred to as the supply security device), where each security device 60 draws current through connections to a power bus 90. Because the system security device and the supply security device are two instances of the same security device, it is expected that the current profiles generated by each security device 60 in response to the same trigger condition will be highly correlated.

The method to eliminate storing the expected current profile statically in memory and to provide for an unlimited number of trigger conditions (challenges) and expected current profiles (responses) is to use a first instance of a security device on the controller (system security device) and another instance of the same security device on the supply item (supply security device) and to dynamically generate and capture the current profile of the system security device in response to a trigger condition and use it as the expected current profile for the supply security device. After the expected current profile is captured from the system security device, the same trigger condition may be used to generate and capture the current profile from the supply security device. Then a comparison of the two current profiles may be made using a suitable verification algorithm and predefined threshold to determine authenticity of the security device on the supply item.

This method is illustrated in the embodiment shown in FIG. 2, where a current profile (as illustrated in FIG. 3 and FIG. 4), generated in response to a trigger condition 115, is captured from the security device 60 on the controller 40 (system security device) and another current profile, generated in response to the same trigger condition, is captured from the security device 60 on the supply item 55. The two captured current profiles are compared with a verification algorithm to determine the authenticity of the security device 60 on a supply item 55. Any suitable verification algorithm may be chosen to measure the statistical correlation (such as the Pearson correlation coefficient but not limited to such) of the two captured current profiles and if the result of the measure of statistical correlation exceeds a predetermined threshold (such as 0.8 or greater but not limited to such) then the security device 60 on the supply item 55 is determined to be authentic and if not the security device 60 on the supply item 55 is determined to be non-authentic. In addition, the trigger condition 115 may be determined by the host firmware 105 operating on the SoC 70 on the controller 40 or by device firmware (not shown) operating on the security device 60 on the controller 40 or by device firmware (not shown) operating on the security device 60 on the supply item 55. Finally, the comparison algorithm with predetermined threshold may be executed in any combination of host firmware executing in whole or in part on the SoC 70 on the controller 40 or device firmware executing in whole or in part on a security device 60 on the supply item 55 or by device firmware executing in whole or in part on a security device 60 on the controller 40.

Similarly, in systems where one instance of a security device 60 is used on the controller 40 (system security device) and multiple additional instances of the same security device 60 are used on supply items 55 (supply security devices), a comparison between the dynamically generated and captured current profile of the system security device and each supply security device may be made using any comparison method and predetermined threshold previously described to determine authenticity of a supply security device 60 on a supply item 55. Moreover, in systems where there is no system security device on the controller (not shown) but where multiple instances of the same security device 60 are used on supply items 55 (supply security devices), it is possible to dynamically generate and capture current profiles for each supply security device 60 and then compare the current profiles of each supply security device with one or more current profiles of other supply security devices using any comparison method and predetermined threshold to determine the authenticity of a security device 60 on a supply item 55 as previously described.

It should be recognized that a method has been disclosed for determining authenticity of security devices 60 on supply items 55 that uses any combination of mutual comparisons, made by any suitable verification algorithm and any predetermined threshold, of current profiles of multiple instances of the same security device 60 either on the controller 40 or on supply items 55 in response to one or more trigger conditions, where the trigger condition is determined by host firmware 105 executing on a SoC 70 on a controller 40 or by device firmware (not shown) executing on a security device 60, where the verification algorithm is executed in whole or in part by host firmware executing on the SoC 70 on the controller 40 or by device firmware executing in whole or in part on a security device 60 on a controller 40 or by device firmware executing in whole or in part by a security device 60 on a supply item 55, and where the expected current profile is predetermined and stored in memory 125 on the controller 40 or in NVM 62 in the security device 60 or is dynamically generated from another instance of the same security device 60 on the controller 40 or on a supply item 55. All combinations of these components described herein are considered part of this invention.

These authentication methods using current profiles may be used for a one-way authentication system where a first device authenticates a second device, but the second device does not authenticate the first device. For example, the host firmware 105 executing on the SoC 70 (first device) may authenticate a security device 60 on a supply item 55 (second device). Moreover, the host firmware 105 executing on the SoC 70 (first device) may authenticate the security device 60 on the controller 40 (second device). Furthermore, the security device 60 on the controller 40 (first device) may authenticate a security device 60 on a supply item 55 (second device). Finally, a security device 60 on a first supply item 55 (first device) may authenticate a security device 60 on a second supply item 55 (second device). In each of the examples, the first device authenticates the second device by executing all or part of the verification algorithm to compare 170 a captured current profile 165 of the second device with an expected current profile, where the expected current profile has been predetermined and stored in memory 109 on the controller 40 or stored in NVM 62 on the security device 60 or is dynamically generated and captured from another security device; and using a predetermined threshold to determine the authenticity of the second security device using any of the methods previously described.

Additionally, these authentication methods using current profiles may be used for a two-way authentication system where a first device authenticates a second device, and the second device authenticates the first device. For example, the security device 60 on the controller 40 (first device) may authenticate a security device 60 on a supply item 55 (second device) and a security device 60 on a supply item 55 (second device) authenticates the security device 60 on the controller 40 (first device). Additionally, a security device 60 on a first supply item 55 (first device) may authenticate a security device 60 on second supply item 55 (second device) and a security device on the second supply item 55 (second device) authenticates a security device 60 on the first supply item 55 (first device). In each of the examples, the first device authenticates the second device by executing all or part of the verification algorithm to compare 170 a captured current profile 165 of the second device with an expected current profile, where the expected current profile has been predetermined and stored in memory 109 on the controller 40 or stored in NVM 62 on the security device 60 or is dynamically generated and captured from another security device; and using a predetermined threshold to determine the authenticity of the second security device using any of the methods previously described.

Finally, these authentication methods using current profiles may be used for a self-authentication system where a security device authenticates itself in whole or in part. For example, the security device 60 on the controller 40 may authenticate itself in whole or in part. Additionally, a security device 60 on a supply item 55 may authenticate itself in whole or in part. In each of the examples, the security device authenticates itself by executing all or part of the verification algorithm to compare 170 a captured current profile 165 of itself with an expected current profile, where the expected current profile has been predetermined and stored in memory 109 on the controller 40 or stored in NVM 62 on the security device 60 or is dynamically generated and captured from another security device; and using a predetermined threshold to determine the authenticity of itself using any of the methods previously described.

### Device Current Profile Measurement

The embodiments previously described, and illustrated in FIG. 2, rely on a current monitor 100 on the controller 40 converting current drawn from a power bus 90 by security device 60 when a trigger condition is detected 115 into an analog voltage that is then converted into a digital output by an analog-to-digital converter (ADC) 110 integrated in the SoC 70 on the controller 40. The digital outputs from the ADC 110 are captured in memory as a current profile 120 and then compared 170 with the expected current profile 125 using a verification algorithm and a predetermined threshold to determine authenticity of a security device 60 on a supply item 55. FIG. 3 and FIG. 4 illustrate example current profiles of an authentic security device 130 and 140 respectively and a non-authentic security device 135 and 145 respectively.

One of the difficulties in developing security devices based on integrated circuit technology (security chips) is that they are susceptible to being reverse engineered and copied using delayering, imaging and netlist extraction techniques that are readily available to attackers. This results in security chips constructed only with standard digital logic gates (e.g., NAND, NOR, INV, FLIP-FLOP, LATCH, etc.) being easily and rapidly copied at low cost. It is desirable to add additional analog features in security chips that are not easily copied and that have unique characteristics to prevent attackers from copying security chips and to use these additional, hard-to-copy analog features for authentication of security devices in combination with the authentication methods based on current profiles disclosed herein.

The method to make security devices more resistant to copying is to integrate an analog-to-digital converter (ADC) in the security device and to use the ADC in the security device for authentication by capturing an internal or external analog parameter (such as a current profile as previously described, but not limited to such) and using an algorithm to compare the captured result to the expected result (such as the expected current profile as previously described but not limited to such) with a predetermined threshold to determine the authenticity of the security device on the supply item.

In the preferred embodiment, shown in FIG. 6, a first instance of a security device 660 with an integrated ADC 663 and a current monitor 664 is placed on the controller 640 and another instance of the same security device 660 with an integrated ADC 663 and a current monitor 664 is placed on a supply item 655. Each security device 660 is connected to the bus master 675 in the SoC 670 on the controller 640 by a shared bus 680. In addition, each security device 660 is connected to a power bus 690 that delivers current to the security devices 660 from a voltage source 685 that is connected 652 to a power supply 650. Each current monitor 664 senses the current drawn from the power bus 690 by the associated security device 660 and converts the sensed current into a voltage that is connected to the input of the ADC 663 of each security device 660. The output from the current monitor 664 on the controller 640 may also (but not necessarily) be connected to the ADC 6110 on the SoC 670. In this embodiment, each security device 660 may generate and capture its own current profile as a response when a trigger condition is detected by the security device 660.

Another embodiment (not shown) is to connect the output of the current monitor 664 on the controller 640 to the input of the ADC 663 of each security device 660 on the controller 640 and on the supply items 655 and to optionally remove the current monitor 664 from the supply item 655. Additionally, another embodiment (not shown) is to place a discrete ADC (not shown) on the supply items 655 and to place a discrete ADC (not shown) on the controller 640 and to connect them to the shared bus 680 and optionally remove the ADC 663 from the security device 660. Many different embodiments are possible (not shown) to generate and capture current profiles on the security device in response when a trigger condition is detected by the security device 660. Each of these embodiments may be used to authenticate security devices using current profiles for a one-way authentication system, two-way authentication, or self-authentication as previously described.

An example of a one-way authentication system using current profiles captured by a security device 660 is now described. The host firmware 6105 on the controller 640 or the device firmware (not shown) on the security device 660 on the controller 640 or the device firmware (not shown) on the security device 660 on the supply item 655 generates an authentication challenge that is sent to the security device 660 on a supply item 655 using any of the methods previously described (e.g. command, series of commands, commands with indirect references, commands that are self-generated, etc). The security device 660 on the supply item 655 executes the command which draws current from a power bus 690, that is sensed and converted into an analog voltage, by the current monitor 664 located with the security device 660 on the supply item 655. The output from the current monitor 664 is connected to the input to the ADC 663 located with the security device 660 on the supply item 655 and converted into one or more digital values by the ADC 663. The digital value(s) from the ADC 663 are captured by the security device 660 on the supply item 655 for a predetermined time period when a trigger condition is detected by the security device 660 while executing the command(s) and then stored in whole or in part in memory 6109 on the controller 640 or in memory on the security device (not shown) as a captured current profile. When a current profile has been captured, as just described, by a security device 660 on a supply item 655 or by a security device 660 on a controller 640, the captured current profile(s) may be encrypted and transmitted to the SoC 670, on the controller 640, over the shared bus 680. The SoC 670 will then use a verification algorithm to compare the captured current profile of the security device 660 with the expected current profile, where the expected current profile has been predetermined and stored in memory 6109 on the controller 640 or stored in NVM 662 on the security device 660 or is dynamically generated and captured from another security device 660; and using a predetermined threshold to determine authenticity of the security device 660 on the supply item 655 or the security device 660 on the controller 640 using any of the methods previously disclosed. Finally, the one-way authentication of each security device 660 may be performed using any of the device authentication methods previously described where the comparison algorithm with predetermined threshold is executed in whole on one device (SoC 670 or security device 660), in whole on multiple devices (SoC 670 or security devices 660), or in part on multiple devices (SoC 670 or security devices 660). Any combination of these device authentication methods may be used for one-way authenticating each individual security device 660.

An example of a two-way authentication system using current profiles captured by a security device 660 is now described. When a current profile has been captured (as described for one-way authentication) by a first security device 660 on a first supply item 655, the captured current profile may be encrypted and transmitted to a second security device 660, on the controller 640 or on another supply item 655, over the shared bus 680. The second security device 660 will then use an algorithm to compare the captured current profile of the first security device with the expected current profile, where the expected current profile has been predetermined and stored in memory 6109 on the controller 640 or stored in NVM 662 on the first security device 660 or is dynamically generated and captured from another security device 660; and using a predetermined threshold to determine authenticity of the first security device 660 on a supply item 655 using any of the methods previously disclosed. To complete the two-way authentication, the roles of the first security device 660 on a supply item 655 and the second security device 660 on the controller 640 or on another supply item 655 are exchanged and the authentication is carried out as just described. Finally, the two-way authentication of each security device 660 combination (SoC and security device or security device and security device) may be performed using any of the device authentication methods previously described where the comparison algorithm with predetermined threshold is executed in whole on one device (SoC 670 or security device 660), in whole on multiple devices (SoC 670 or security devices 660), or in part on multiple devices (SoC 670 or security devices 660). Any combination of these device authentication methods may be used for two-way authenticating each security device 660 combination (SoC and security device or security device and security device).

An example of a self-authentication system using current profiles captured by a security device 660 is now described. When a current profile has been captured (as described for one-way-authentication) by a security device 660 on a supply item 655 or by a security device 660 on a controller 640, the same security device (self-verification) may then use an algorithm to compare in whole or in part the captured current profiles with the expected current profile, where the expected current profile has been predetermined and stored in memory 6109 on the controller 640 or stored in NVM 662 on the security device 660 or is dynamically generated and captured from another security device 660; and using a predetermined threshold to determine authenticity of the security device 660 on the supply item 655 or the security device 660 on the controller 640 using any of the methods previously disclosed. Finally, the self-authentication of each security device 660 may be performed using any of the device authentication methods previously described where the comparison algorithm with predetermined threshold is executed in whole on one device (SoC 670 or security device 660), in whole on multiple devices (SoC 670 or security devices 660), or in part on multiple devices (SoC 670 or security devices 660). Any combination of these device authentication methods may be used for self-authenticating each individual security device 660.

It should be recognized that a method has been disclosed for determining authenticity of security devices 660 on supply items 655 and on a controller 640 that uses current profiles as an authentication parameter in any combination of one-way authentication (one device authenticates another device), two-way authentication (two devices authenticate each other), and self-authentication (a device authenticates itself) where the device performing the authentication executes one or more comparisons of a captured current profile with an expected current profile using any suitable verification algorithm and any predetermined threshold, to determine the authenticity of the security device 660 on the controller 640 or on the supply item 655 based on a match of the current profiles of multiple instances of the same security device either on the controller or on supply items in response to one or more trigger conditions.

Other embodiments disclosed include, first, a method of determining authenticity of a component in an imaging device by authenticating current profiles, comprising the execution of a challenge command by a security device firmware at multiple frequencies, where the challenge command is generated by a host and sent to a security device or where a challenge command is self-generated by a security device.

Second, a method of determining authenticity of a component in an imaging device by authenticating current profiles, comprising the execution of a challenge command by a security device firmware at multiple security levels, where a challenge command is generated by a host and sent to a security device or where a challenge command is self-generated by a security device.

Third, a method of determining authenticity of a component in an imaging device by authenticating current profiles, comprising the execution of a verification algorithm by a security device firmware to compare, in whole or in part, a captured current profile with an expected current profile to self-verify, in whole or in part, the authenticity of a security device, where the verification algorithm is a comparison of one or more digital values versus a fixed threshold or where a verification algorithm is a statistical correlation of one or more digital values with a predetermined threshold for correlation.

Fourth, a method of determining authenticity of a component in an imaging device by authenticating current profiles, comprising the steps of: execution of a command monitoring algorithm by a security device firmware to determine when a trigger condition is satisfied; and communicating from the security device to a system on chip that a trigger condition is satisfied, by an encrypted message over a shared bus or by a direct connection.

The foregoing description illustrates various aspects and examples of the present disclosure. It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

We claim:

1. A method of determining authenticity of a component in an imaging device, comprising:
determining whether a command sent to the component satisfies a trigger condition;
upon determining that the command satisfies the trigger condition, generating a current profile indicating current drawn by the component when the component performs an operation in response to receiving the command; and
determining whether the component is an authorized component for use in the imaging device based on the generated current profile.

2. The method of claim 1, wherein the determining whether the component is an authorized component includes comparing the generated current profile with an expected current profile.

3. The method of claim 1, wherein the trigger condition corresponds to a command that results in a maximum power consumption of the component when the component performs the operation in response to receiving the command.

4. The method of claim 1, wherein the trigger condition corresponds to a command that results in a minimum power consumption of the component when the component performs the operation in response to receiving the command.

5. The method of claim 1, wherein the generating the current profile includes sampling an output of a current monitor sensing current drawn by the component when the component performs the operation in response to receiving the command.

6. The method of claim 5, wherein the sampling the output of the current monitor is performed within a predetermined time period.

7. The method of claim 1, further comprising initiating a secondary internal operation in the component in response to the component receiving the command, wherein the operation corresponds to the secondary internal operation that is different from a primary internal operation performed by the security device in response to the command.

8. The method of claim 7, wherein the initiating the secondary internal operation in the component is performed when the command has been sent to the component a predetermined number of times.

9. A method of determining authenticity of a component in an imaging device by authenticating current profiles, comprising the steps of:
reading an expected current profile that is stored encrypted in non-volatile memory in a security device, where the current profile is device specific or non-device specific
reading a digital signature of the current profile combined with device specific information, such as device serial number or part number, that is stored encrypted in non-volatile memory in the security device;
executing a decryption algorithm using a device specific key to decrypt the expected current profile read from the non-volatile memory of the security device, into plaintext;
executing a decryption algorithm using a device specific key to decrypt the digital signature, read from the non-volatile memory in the security device, into plaintext;
executing a digital signature verification algorithm using a public key to verify the decrypted digital signature is valid;
executing an encryption algorithm using a shared session key, to encrypt the expected current profile and device specific digital signature; and
executing a command to transmit the encrypted expected current profile and digital signature to a system on chip over a shared bus.

10. A security device on a supply item comprising:
an integrated analog-to-digital converter; and
a current monitor, wherein the security device is connected to a bus master on a system-on-chip on a controller by a shared bus, each security device is connected to a power bus that delivers current to the security device from a voltage source that is connected to a power supply, and further wherein the current monitor senses the current drawn from the power bus by the security device and converts the sensed current into a voltage that is connected to the input of the analog-to-digital converter.
